(19) United States
(12) Patent Application Publication
(10) Pub. No.: US 2015/0334220 A1
(43) Pub. Date: Nov. 19, 2015

(54) Smartphone holder providing usb connectivity and tripod support

(71) Applicant: Daniel E. Shannon, North Las Vegas, NV (US)

(72) Inventor: Daniel E. Shannon, North Las Vegas, NV (US)

(21) Appl. No.: 14/120,253

(22) Filed: May 13, 2014

(51) Int. Cl. H04M 1/725; H04M 1/04

(52) U.S. Cl. CPC H04M 1/72527; H04M 1/04

(57) ABSTRACT

A smartphone holder has a removable rubberized clamping assembly at an upper end thereof for securing a smartphone or other device in a desired position. A reversible male USB connector protruding from the lower end of the holder permits use of the smartphone regardless of the orientation of an external female USB connector to which the male USB connector is connected. A fixed or pivoting male electrical connector protruding from the upper end of the smartphone holder is electrically connected within a flexible central body member of the smartphone holder to the reversible male USB connector to facilitate battery charging and data transfer between the smartphone and an external USB device. A pair of flexible side leg members and a central body member may be separately bent outwardly from a point of attachment to each other to form a self-supporting tripod shape for holding a smartphone in a desired position.

### CROSS-REFERENCE TO RELATED APPLICATION

This application incorporates by reference the subject matter and claims the priority benefit of U.S. Provisional Patent Application Ser. No. 61/855,272 filed on May 13, 2013.

### BACKGROUND AND SUMMARY OF THE INVENTION

This invention relates generally to portable electronic devices and accessories, and, more particularly, to a holder for smartphones, tablet computers, MP3 music players, electronic E-readers, compact cameras, etc. that provides tripod support, if desired, and USB connectivity for battery charging and data transfer purposes.

Smartphones are well understood to be cellular telephones having large display screens and integrated cameras that may be connected to the interne for downloading application programs and performing many other tasks online. Because of their expanded capabilities, these devices put a high demand on batteries and must be connected to other devices such as computers for the purpose of data sharing and backup.

The cameras integrated in smartphones have become so sophisticated that they often serve as replacements for dedicated compact cameras. A number of smartphone photography application programs permit photo enhancement and manipulation that go beyond the capabilities of compact cameras. Thus, smartphones have become high quality and versatile cameras but, unlike compact cameras, have no capability for being mounted on a tripod.

Smartphones have the capability of performing video conferencing functions using a second camera on the display side of the phone. In this application, the smartphone must be positioned facing the operator for the duration of the conference call.

Given the large number of power-consuming applications that may typically be installed on a smartphone, it is oftentimes necessary to have ready access to a battery charger to maintain operating power during the course of anticipated usage.

It would therefore be advantageous to provide a pocket-sized holder for smartphones and other devices that has the capability of forming a tripod and display stand for use during photography sessions and video conference calls, for example, and that provides USB connectivity between connected electronic devices.

This and other advantages are provided in accordance with the illustrated preferred embodiment of the present invention in which a smartphone holder includes a removable rubberized clamping mechanism at an upper end thereof that secures a smartphone or other device in either a horizontal or vertical position of orientation. A reversible male USB connector protruding from the opposite lower end of the smartphone holder permits use of the smartphone, while connected, regardless of the orientation of an external female USB connector to which the smartphone holder is attached. A male electrical connector protruding from the upper end of the smartphone holder is electrically connected within a flexible central body member of the smartphone holder to the reversible male USB connector at the lower end of the smartphone holder to facilitate charging the battery of the connected smartphone and transferring data between the smartphone and an external computer or other USB device connected to the reversible male USB connector. The body of the smartphone holder includes a pair of flexible side leg members positioned on opposite sides of the flexible central body member. The two flexible side leg members and the flexible central body member are fixedly attached to each other at the top of the smartphone holder, but can be separately bent outwardly below the point of attachment to transform the otherwise linear shape of the smartphone holder into a self-supporting tripod shape for holding a smartphone or other device in a desired position that may be convenient for use in photographic, video conferencing or other applications. A notch formed in each of the two flexible side leg members proximate the distal free ends thereof prevents horizontal movement of a smartphone or other supported device when the smartphone holder is lying flat with its flexible central body member bent upwardly to provide display easel support of the smartphone.

In accordance with another embodiment of the present invention, a tripod adaptor employed with the removable clamping mechanism of the smartphone holder facilitates mounting of a smartphone or other device to a conventional camera tripod.

In accordance with another embodiment of the present invention, a compact camera adaptor employed with the smartphone holder facilitates connection of a conventional compact camera thereto. By bending the two flexible side leg members and the flexible central body member outwardly to form a tripod, the compact camera may be supported in a desired position.

In accordance with another embodiment of the present invention, the fixedly-positioned male electrical connector protruding from the top of the smartphone holder is replaced with a spring-loaded male USB connector that pivots between an open position of use and a concealed closed position. A light emitting diode on the smartphone holder is illuminated when power is supplied to the pivoting male USB connector.

In accordance with another embodiment of the present invention, a battery cavity in the body of the smartphone holder, accessible from the underside thereof, is adapted to receive a supplemental rechargeable battery that provides operating or charging power to an attached smartphone when the smartphone's internal battery is depleted. The reversible male USB connector at the lower end of the smartphone holder is internally connected to the supplemental battery to facilitate charging it when the smartphone holder is connected to an external source of power via the reversible male USB connector, whether or not a smartphone is connected to the smartphone holder.

### BRIEF DESCRIPTION OF THE DRAWINGS

FIG. 1 is a perspective view of the smartphone holder of the present invention illustrating the rubberized clamping members at the upper end of the holder body in their closed position.

FIG. 2 is an exploded perspective view of the smartphone holder of FIG. 1 illustrating the rubberized clamping members in their open position.

FIG. 3 is an enlarged perspective view of the removable clamping assembly at the upper end of the smartphone holder of FIGS. 1 and 2, illustrating the rubberized clamping members in their open position, ready to accept a smartphone.

FIG. 4 is a perspective view of the clamping assembly of FIG. 3 of the smartphone holder of FIGS. 1 and 2, illustrating an initial position in preparation for attachment of the smartphone holder to a smartphone.

FIG. 5 is a perspective view of the clamping assembly of FIG. 3 of the smartphone holder of FIGS. 1 and 2, illustrating an intermediate position as it is being attached to a smartphone.

FIG. 6 is a perspective view of the clamping assembly of FIG. 3 of the smartphone holder of FIGS. 1 and 2, illustrating its final position of attachment to a smartphone.

FIG. 7 is a perspective view of the lower portion of the smartphone holder of FIGS. 1 and 2, illustrating a reversible male USB connector for connecting the smartphone holder to an external device, a connector housing, and a protective cover that fits over both the USB connector and its housing.

FIG. 8 is a perspective view of the two-sided reversible USB connector contained within the smartphone holder of FIGS. 1 and 2, illustrating the crossover connections required on one side of the USB connector.

FIG. 9 is a perspective view of the two-sided USB connector of FIG. 8 in a position of pre-attachment to a standard female one-sided USB connector that is external to the smartphone holder.

FIG. 10 is a perspective view of the two-sided USB connector of FIG. 8 fully attached to the external female one-sided USB connector of FIG. 9.

FIG. 11 is a perspective view of the smartphone holder of FIGS. 1 and 2 electrically connected and physically clamped to a smartphone and also flexibly connected to a standard USB wall charger that is plugged into a conventional household AC electrical outlet.

FIG. 12 is a perspective view of the smartphone holder of FIGS. 1 and 2 electrically connected and physically clamped to a smartphone and also connected to a USB port on an external computer.

FIG. 13 is a perspective view of the smartphone holder of FIGS. 1 and 2 clamped to a smartphone with its two flexible side leg members and its flexible central body member bent outwardly to form a tripod for supporting the smartphone in a desired position.

FIG. 14 is a perspective view of an adaptor for connecting a smartphone to a standard photo tripod.

FIG. 15 is an exploded perspective view illustrating the way in which the adaptor of FIG. 14 connects a smartphone to a standard photo tripod.

FIG. 16 is a perspective view of the smartphone and photo tripod of FIG. 15 connected to each other.

FIG. 17 is a perspective view of an adaptor for connecting the smartphone holder of FIGS. 1 and 2 to a conventional compact camera.

FIG. 18 is an exploded perspective view illustrating the way in which the adaptor of FIG. 17 connects the smartphone holder of FIGS. 1 and 2, with its two flexible side leg members and its flexible central body member bent outwardly to form a tripod, to a conventional compact camera.

FIG. 19 is a perspective view of the smartphone holder and conventional compact camera of FIG. 18 connected to each other.

FIG. 20 is a perspective view of the smartphone holder of FIGS. 1 and 2 illustrating an alternative pivoting male USB connector protruding from the upper end of the smartphone holder.

FIG. 21 is an exploded perspective view of the smartphone holder of FIG. 20 illustrating the structural details of the alternative pivoting male USB connector.

FIG. 22 is a perspective view of the underside of the smartphone holder of FIGS. 20 and 21 with provision for receiving an optional battery in a battery cavity thereof.

FIG. 23 is a side elevation view of the smartphone holder of FIGS. 1 and 2 with its flexible central body member bent upward to form a display easel for supporting a smartphone or other device in a desired position.

### DESCRIPTION OF THE PREFERRED EMBODIMENT

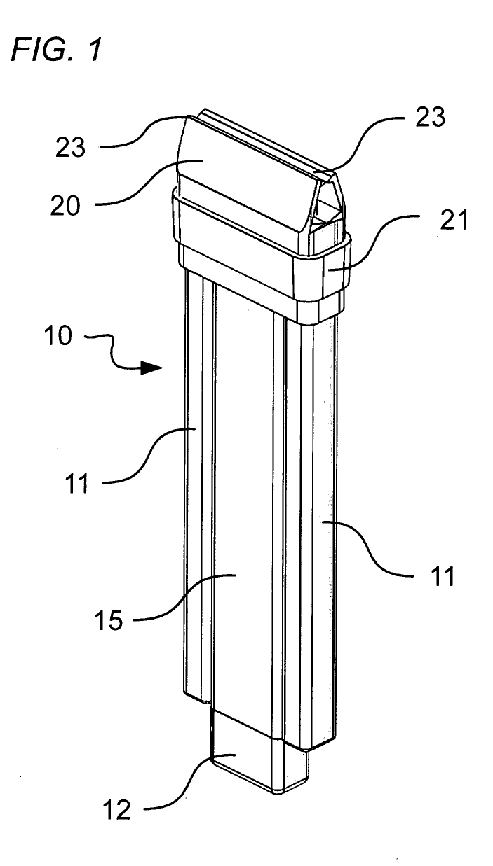

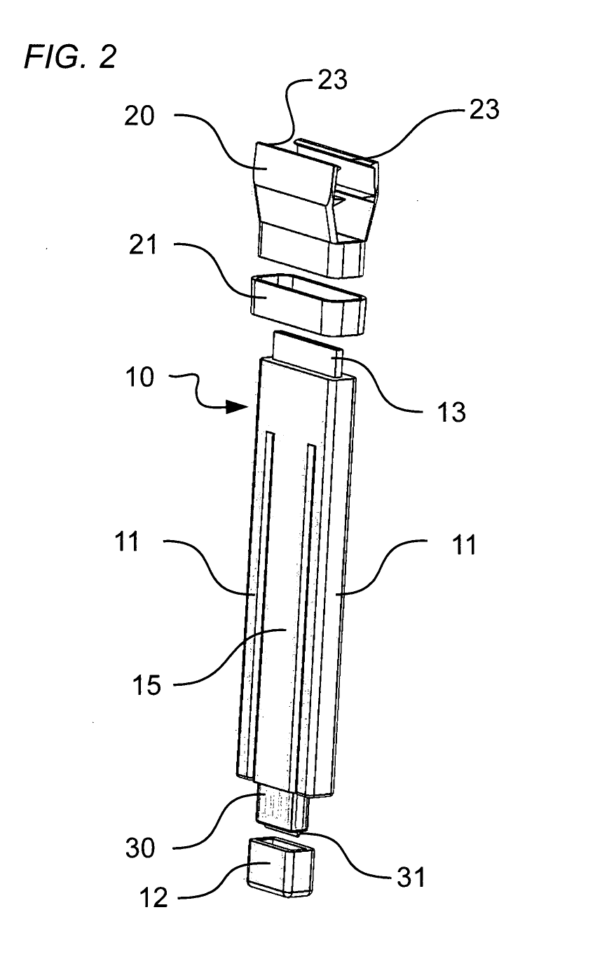

Referring now to FIGS. 1 and 2, there is shown a smartphone holder 10 in accordance with the present invention. The body of the smartphone holder 10 includes a pair of flexible side leg members 11 and a flexible central body member 15, all three of which are illustrated in their stowed positions. A removable clamping assembly includes a pair of rubberized clamping members 20 at the upper end of smartphone holder 10 that serve to releasably secure a smartphone or other device between opposing rubberized jaws 23 of clamping members 20. A clamping collar 21 slidably engages clamping member 20 to open and close opposing rubberized jaws 23. A smartphone male electrical connector 13 protrudes from the upper end of the body of smartphone holder 10, and a reversible USB connector 31, together with its housing 30, protrude from the lower end thereof. A removable end cap 12 covers USB connector 31 and its housing 30 to protect them from dust and debris when not in use.

Referring now additionally to the detailed diagram of FIG. 3, it may be seen how clamping members 20 are closed in response to upward movement of clamping collar 21 and opened in response to downward movement thereof. Clamping collar 21 is held in place when clamping members 20 are in their closed position over a smartphone or other device by engagement with the sawtooth-shaped ridges of a ratchet surface 22 formed on the lower outer surface of clamping members 20. A rubberized bottom shelf 24 formed on the inside surface of each of clamping members 20 maintains the clamped smartphone or other device in a desired position away from electrical connector 13 when electrical connection thereto is not required. A pair of squeeze pads 25 on opposite sides of clamping collar 21 serve to release clamping members 21 when the shape of clamping collar 21 is deformed by squeezing pads 25 together to thereby release clamping collar 21 from frictional contact with ratchet surface 22. The inside surface 26 of clamping collar 21 fits snugly over the body of smartphone holder 10 and is deformed slightly by the clamping collar 21, thus holding the entire clamping mechanism together when the clamping collar 21 is raised to either clamp a smartphone between jaws 23 of clamping members 20 or to close clamping members 20 against each other in the absence of a smartphone, thus acting as a protective end cover for smartphone holder 10. The clamping assembly shown in detail in FIG. 3, consisting of clamping members 20 and clamping collar 21, may be removed from the main body of smartphone holder 10, if desired, for the purpose of clamping any of a number of devices that do not require the USB data transfer and battery charging connectivity otherwise provided by the body portion of smartphone holder 10, such as reflectors, mirrors, small electronic flashes, and adaptors for holding compact cameras.

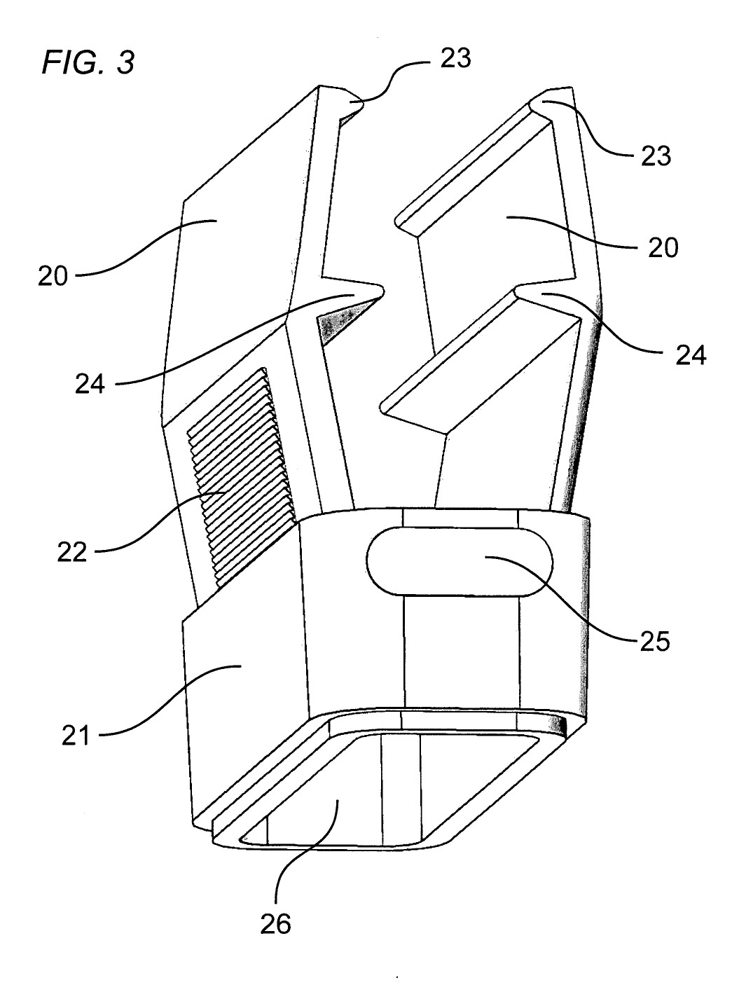

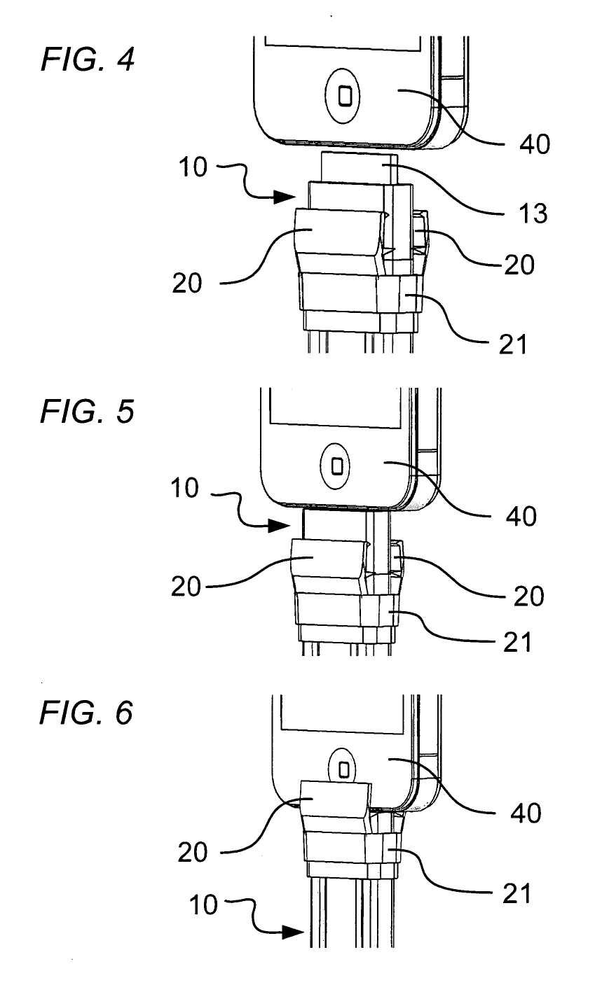

Referring now collectively to FIGS. 4-6, there is shown the way in which a smartphone 40 is attached to smartphone holder 10 by first lowering clamping collar 21 to open clamping members 20, thereby exposing male electrical connector 13 for insertion into a corresponding female electrical connector conventionally located at the lower end of smartphone 40. FIG. 6 shows electrical connector 13 fully inserted into smartphone 40.

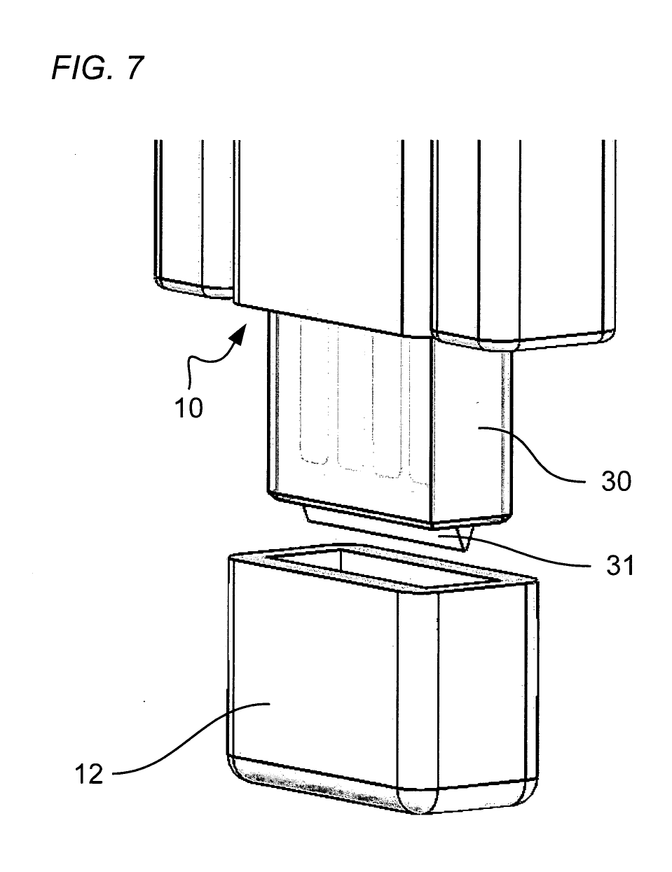

Referring now to FIG. 7, there is shown an enlarged view of the lower portion of the body of smartphone holder 10, illustrating the two-sided reversible male USB connector 31, its housing 30, and their protective cover 12.

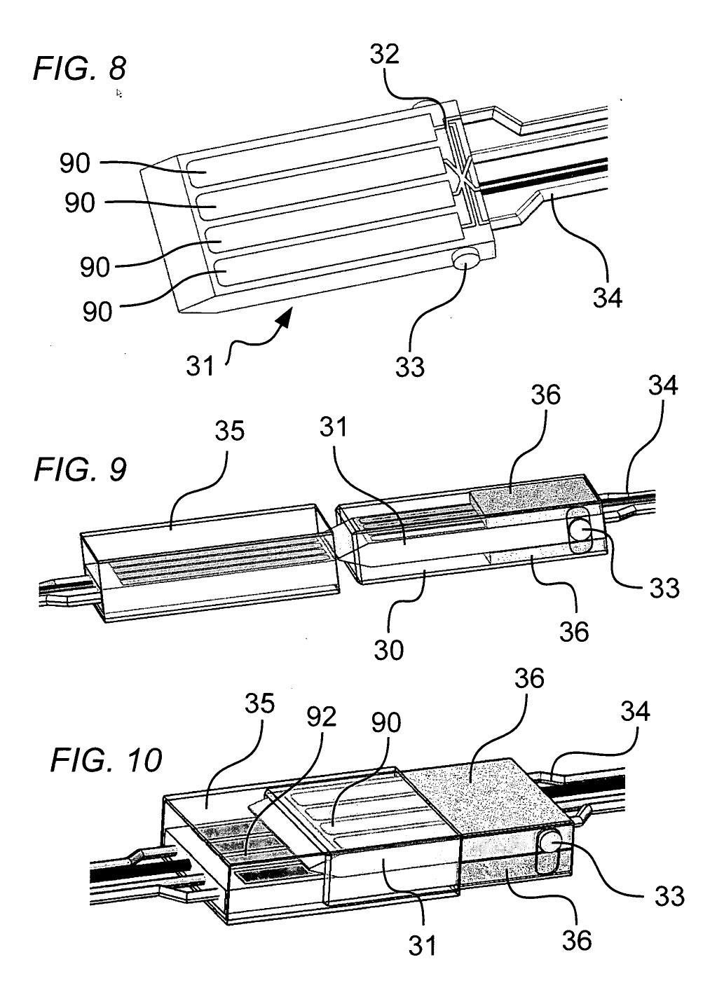

Referring now to FIGS. 8 and 9, there is shown the two-sided reversible male USB connector 31 contained within the smartphone holder of FIGS. 1 and 2. FIGS. 8 and 9 illustrate the crossover electrical connections 32 that are required on one side of the male USB connector 31 in order to electrically connect each one of conventional longitudinal electrical traces 90 on one side of USB connector 31 to corresponding ones of like traces on the reverse side thereof and to corresponding ones of electrical wires 34, in order to render male USB connector 31 electrically reversible. A protruding post 33 provided on each side of the male USB connector 31 serves to maintain its attachment in a fixed horizontal position within connector housing 30, while allowing it to float vertically, as required to engage an aligned external female USB connector 35 that may be mounted within a conventional smartphone battery charger transformer or computer. Male USB connector 31 is maintained in a vertically-centered position within connector housing 30, when disengaged from female USB connector 35, by means of two foam pads 36 that are respectively positioned on the top and bottom surfaces of USB connector 31. FIG. 9 illustrates the two USB connectors 31, 35 in a position of slight separation, as happens when connecting or disconnecting them.

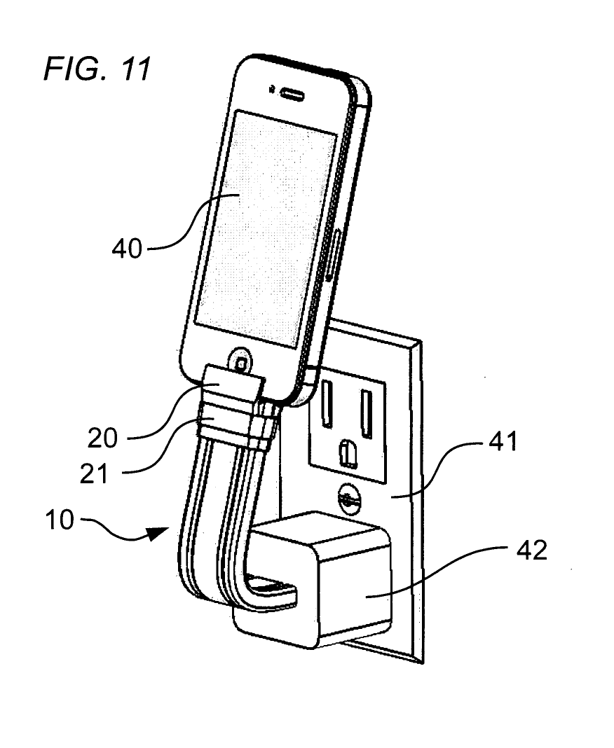

Referring now to FIG. 10, there is shown the two-sided reversible male USB connector 31 fully engaged with external female USB connector 35. In this position, the upper one of foam pads 36 is compressed to urge male USB connector 31 downward within female USB connector 35 to ensure good electrical contact between the electrical traces 90 on male USB connector 31 and corresponding electrical traces 92 within conventional external female USB connector 35.

Referring now to FIG. 11, there is shown the smartphone holder 10 of FIGS. 1 and 2, electrically connected to a smartphone 40, and also flexibly connected to a standard USB wall charger 42 that is plugged into a household AC electrical outlet 41.

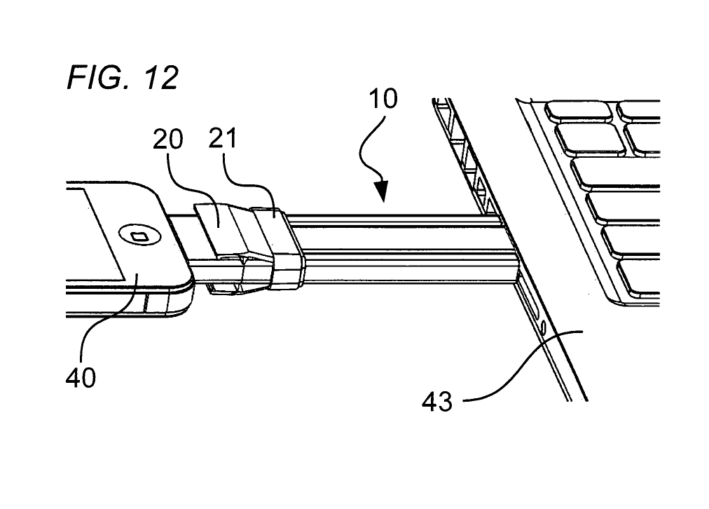

Referring now to FIG. 12, there is shown the smartphone holder 10 of FIGS. 1 and 2, electrically connected to a smartphone 40, and also electrically connected to a conventional USB port on a computer 43.

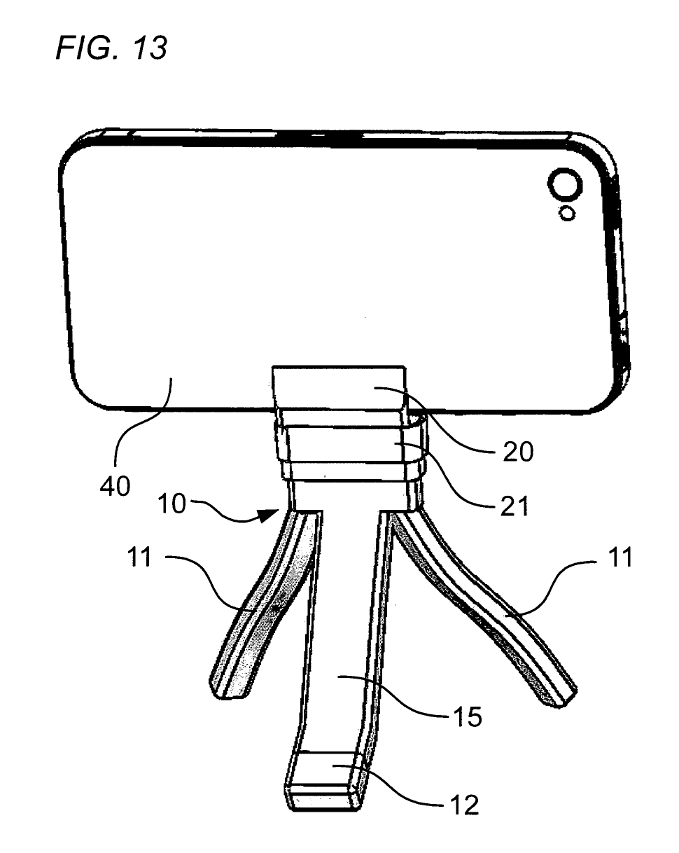

Referring now to FIG. 13, there is shown the smartphone holder 10 of FIGS. 1 and 2, electrically connected to a smartphone 40. Flexible side leg members 11 and flexible central body member 15 are bent outwardly, as illustrated, to form a tripod that supports smartphone holder 10 and smartphone 40 in an upright position. Each of the flexible side leg members 11 and flexible central body member 15 is conventionally constructed to include a skeleton formed of flexible armature wire or some other flexible material that retains a shape to which it has been most recently formed, covered by a molded outer cover such as silicon. The two flexible side leg members 11 and the flexible central body member 15 are fixedly attached to each other at the top of the smartphone holder 10, but can be separately bent outwardly below the point of attachment to transform the otherwise linear shape of the smartphone holder 10 into a self-supporting tripod shape for holding a smartphone or other device.

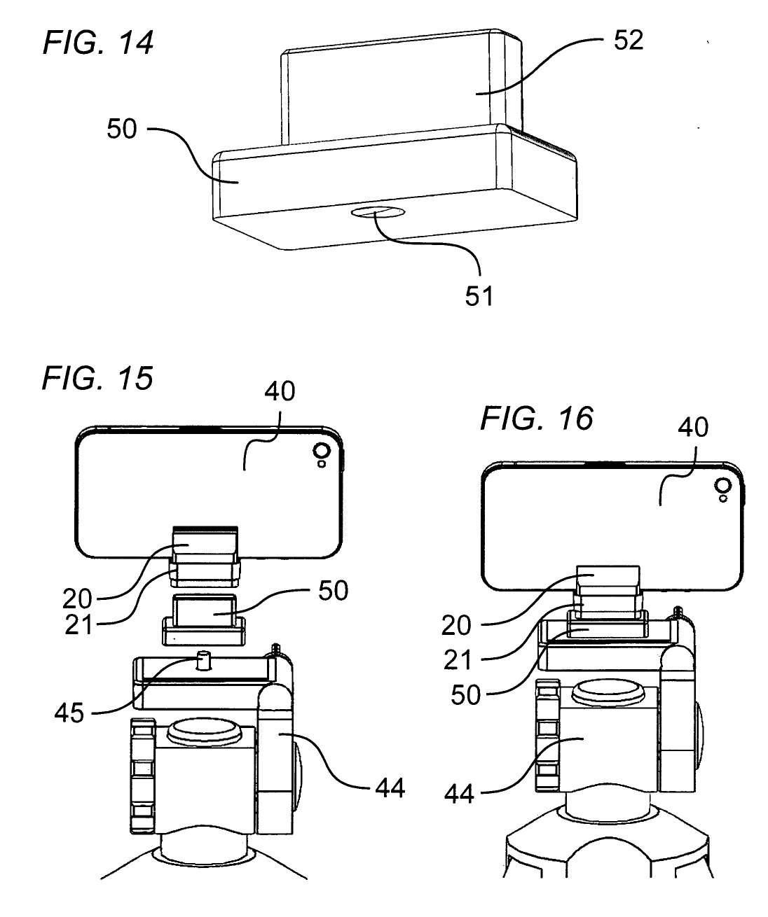

Referring now to FIG. 14, there is shown a perspective view of an adaptor 50 for connecting a smartphone 40 to a conventional camera tripod. Adaptor 50 includes a threaded industry-standard tripod mounting hole 51 and a mounting post 52. Mounting post 52 is sized such that the removable clamping assembly of smartphone holder 10 of FIGS. 1 and 2, when removed, will fit over mounting post 52, as illustrated in the assembly drawing of FIG. 15. As also shown in FIG. 15, camera tripod adaptor 50 is attached to a conventional camera tripod 44 by means of a mounting bolt 45 that is conventionally included on camera tripod 44. FIG. 16 shows smartphone 40, connected in the way just described, to camera tripod 44.

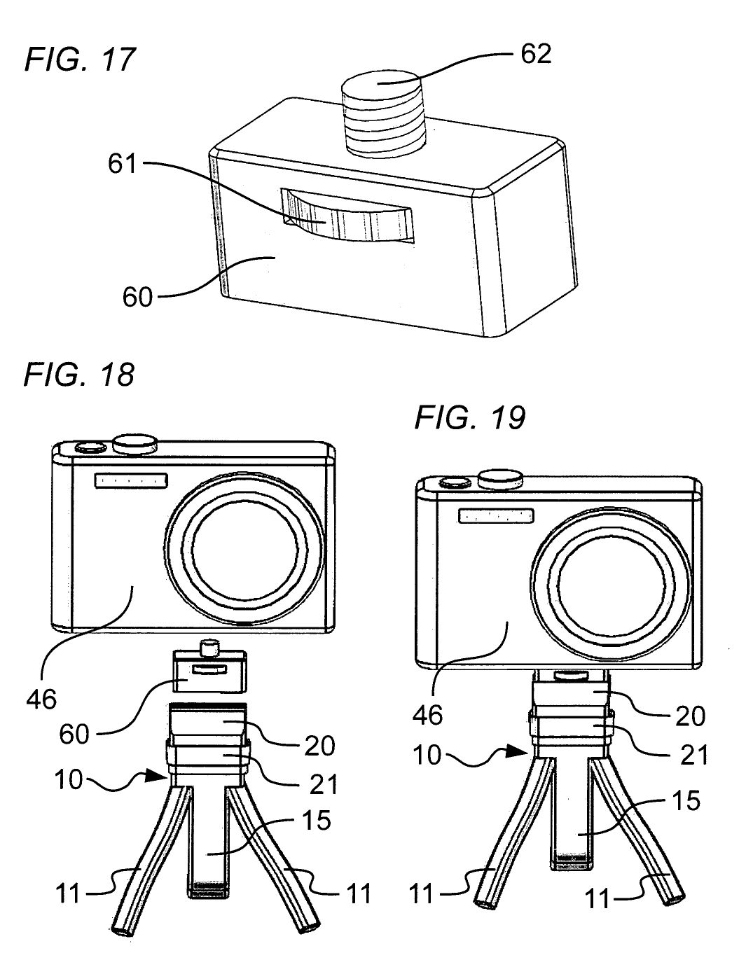

Referring now to FIGS. 17-19, there is shown a perspective view of an adaptor 60 for connecting smartphone holder 10 of FIGS. 1 and 2 to a conventional compact camera. Adaptor 60 includes a threaded industry-standard tripod mounting bolt 62 protruding upwardly from the top surface thereof, rotation of which is controlled by an attached thumb wheel 61, for connecting and disconnecting a compact camera 46. As also illustrated in FIGS. 18 and 19, flexible side leg members 11 and flexible central body member 15 of smartphone holder 10 are bent outwardly to form a tripod for supporting smartphone holder 10, compact camera adaptor 60, and compact camera 46.

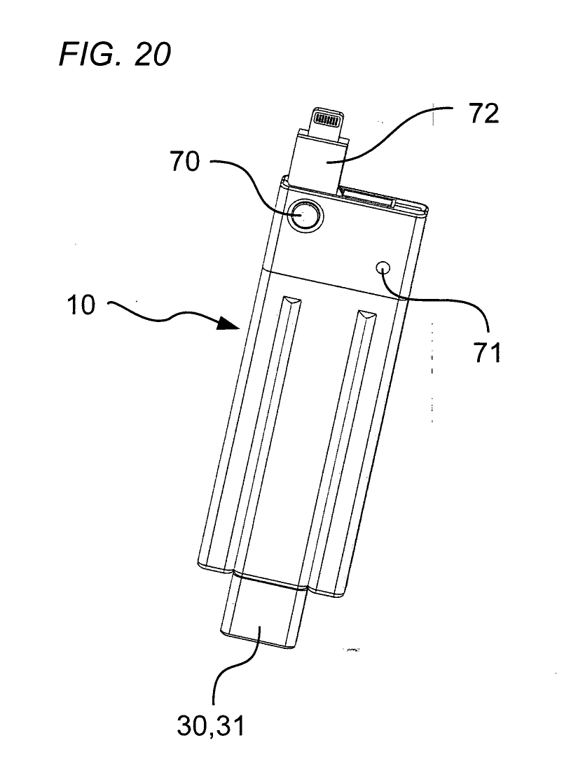

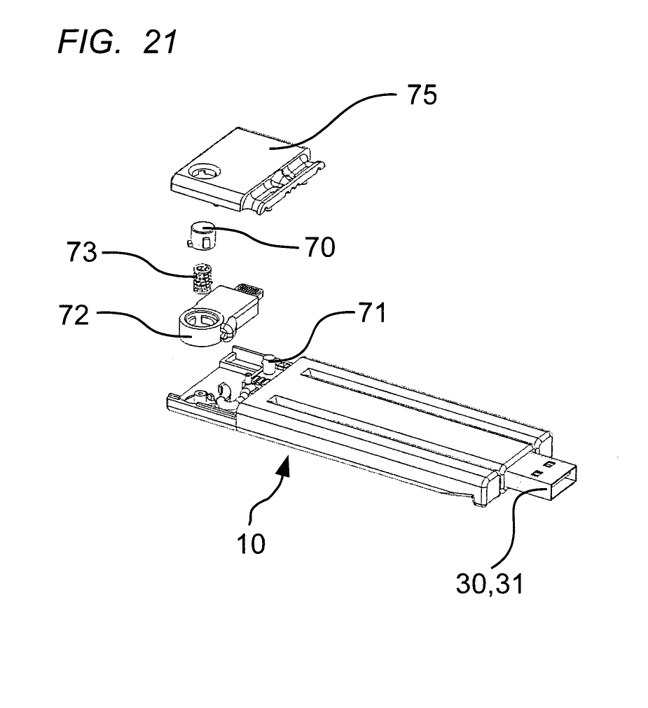

Referring now to FIGS. 20 and 21, there is shown an alternative embodiment of the smartphone holder 10 of FIGS. 1 and 2 in which a smaller pivoting male connector 72 replaces the larger male electrical connector 13. A push button 70 serves to release connector 72 from its closed, concealed position illustrated in FIG. 21 to its open position shown in FIG. 20. Pressing push button 70 a second time allows the user to manually return pivoting male connector 72 to its concealed position. A light emitting diode 71 is illuminated when power is supplied to male connector 72 via USB connector 30, 31, for example. As shown in the exploded view of FIG. 21, push button 70, a dual action spring 73, and male connector 72 are held in place by a top cover 75 of a split case. Push button 70 includes two catch pins that fit into a corresponding slot on male connector 72. Dual action spring 73 acts as a lateral compression spring, releasing the pressure resulting when the operator depresses push button 70. Spring 73 also acts as a radial coiled spring, urging pivoting male connector 72 in a counter clockwise direction to thereby move it into its open position. Pivoting male connector 72 is held in its concealed, closed position by one of the catch pins on push button 70. When push button 70 is depressed, the two catch pins are separated from the corresponding slot on pivoting male connector 72, and pivoting USB connector is forced into its open position by dual action spring 73. Pivoting male connector 72 is held in its open position by the other catch pin on push button 70 until the user depresses push button 70, while simultaneously manually rotating male connector 72 to its closed, concealed position.

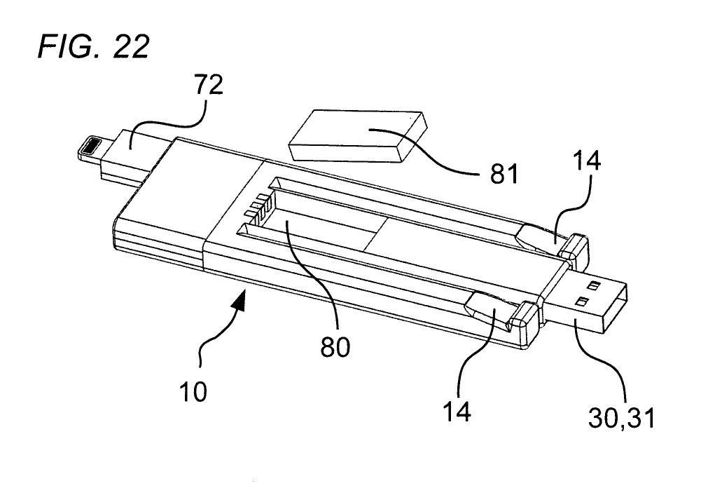

Referring now to FIG. 22, there is shown the underside of the smartphone holder 10 of FIGS. 20 and 21 having a battery cavity 80 in the body thereof for receiving a supplemental battery 81. Power supplied by supplemental battery 81 may be used to operate or charge a smartphone connected to smartphone holder 10 when the smartphone's internal battery is depleted. Battery 81 is itself charged when USB connector 30, 31 of smartphone holder 10 is connected to an external USB device or other power source, whether or not a smartphone is connected to smartphone holder 10. A battery cavity and battery, like battery cavity 80 and battery 81 illustrated in FIG. 22, may as well be provided in the embodiment of smartphone holder 10 illustrated in FIGS. 1 and 2.

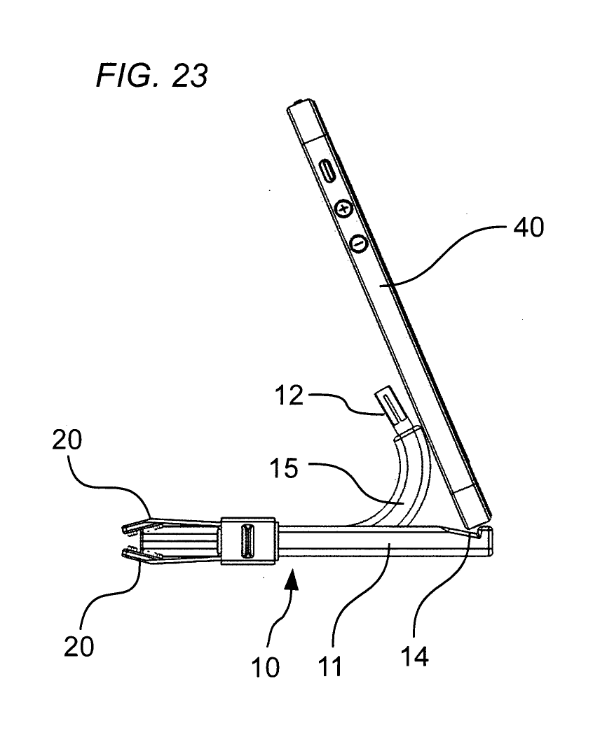

Referring now to FIG. 23, there is shown a side elevation view of the smartphone holder 10 of FIGS. 1 and 2, lying flat with its flexible central body member 15 bent upwardly to form a display easel support for holding a smartphone 40 or other device in a desired display position. A notch 14 molded or otherwise formed near the distal ends of each of the flexible side leg members 11 prevents horizontal movement of the smartphone 40 from its desired display position.

I claim:

1. A smartphone holder comprising:
a flexible central body member;
a pair of flexible side leg members positioned adjacent said central body member on opposite sides thereof, said central body member and said pair of side leg members being fixedly attached to each other at an upper end of said smartphone holder, said flexible central body member and said pair of flexible side leg members being separately outwardly bendable below a point of attachment to transform an otherwise linear shape of the smartphone holder into a self-supporting tripod shape;
a removable clamping assembly positioned over said upper end of said smartphone holder for releasably securing an external smartphone or other device;
a smartphone male electrical connector protruding from the upper end of said smartphone holder, said male electrical connector engaging a mating female electrical connector of said external smartphone or other device when said external smartphone or other device is secured by said clamping assembly of said smartphone holder; and
a two-sided reversible male USB connector protruding from a lower end of said smartphone holder for connection to a mating USB port of an external device, said smartphone male electrical connector and said reversible male USB connector being electrically connected to each other by wires within said central body member of said smartphone holder.

2. A smartphone holder as in claim 1, wherein said clamping assembly comprises:
a pair of opposing clamping members, each of said clamping members comprising a pair of inwardly-facing jaws for contacting a smartphone or other external device being secured by said smartphone holder, each of said clamping members comprising an inwardly facing bottom shelf formed below said jaws for maintaining said secured smartphone or other device in a desired position away from said male electrical connector when electrical connection thereto is not required, a lower exterior surface of each of said clamping members comprising a ratchet surface having a multiplicity of sawtooth-shaped ridges formed thereon; and
a clamping collar positioned over a lower portion of said clamping members for sliding engagement therewith such that said clamping members are closed in response to upward movement of said clamping collar and opened in response to downward movement thereof, said clamping members being held in their closed position by frictional engagement of said clamping collar with said sawtooth-shaped ridges of said ratchet surface.

3. A smartphone holder as in claim 2, wherein an exterior surface of each said clamping members and said bottom shelf comprises a rubberized material.

4. A smartphone holder as in claim 2, further comprising a pair of squeeze pads formed on opposite sides of said clamping collar for the purpose of deforming said clamping collar to thereby release it from frictional engagement with said ratchet surface.

5. A clamping assembly for holding a smartphone or other device in a desired position, comprising:
a pair of opposing clamping members, each of said clamping members comprising a pair of inwardly-facing jaws for contacting a smartphone or other device being secured by said clamping assembly, a lower exterior surface of each of said clamping members comprising a ratchet surface having a multiplicity of sawtooth-shaped ridges formed thereon; and
a clamping collar positioned over a lower portion of said clamping members for sliding engagement therewith such that said clamping members are closed in response to upward movement of said clamping collar and opened in response to downward movement thereof, said clamping members being held in their closed position by frictional engagement of said clamping collar with said sawtooth-shaped ridges of said ratchet surface.

6. A clamping assembly as in claim 5, wherein an exterior surface of each of said pair of clamping members comprises a rubberized material.

7. A clamping assembly as in claim 5, further comprising a pair of squeeze pads formed on opposite sides of said clamping collar for the purpose of deforming said clamping collar to thereby release it from frictional engagement with said ratchet surface.

8. A smartphone holder as in claim 1, wherein said flexible central body member and said pair of flexible side leg members are collectively bendable below said point of attachment to transform the otherwise linear shape of the smartphone holder into a curved shape.

9. A smartphone holder as in claim 1, wherein said reversible male USB connector comprises:
a plurality of longitudinal electrical traces on a first side thereof;
a like plurality of longitudinal electrical traces on a reverse side thereof; and
a plurality of crossover electrical connections on a selected side of said male USB connector for electrically connecting each one of said plurality of electrical traces on said first side thereof to corresponding ones of said plurality of electrical traces on said reverse side thereof.

10. A smartphone holder as in claim 9, further comprising:
a connector housing for retaining said reversible male USB connector;
an elongated vertical slot in opposite side surfaces of said connector housing at a proximal end thereof;
a compressible member positioned within said connector housing between inner top and bottom surfaces of said connector housing and each of said first and reverse sides of said male USB connector;
an outwardly protruding post on opposite side edges of said male USB connector positioned in each of said vertical slots for maintaining attachment of said male USB connector in a fixed horizontal position within said connector housing, while allowing said male USB connector to float vertically within said connector housing, against said compressible members, as required to engage an aligned external mating USB port, said compressible members serving to maintain said male USB connector in a vertically-centered position within said connector housing, when said male USB connector is disengaged from said external mating USB port.

11. A smartphone holder as in claim 10, wherein said compressible member comprises a foam pad.

12. A clamping assembly as in claim 5, further comprising a camera tripod adaptor for connecting said clamping assembly to a conventional camera tripod, said camera tripod adaptor comprising an upper mounting post and a lower base member, said lower base member including a threaded bolt opening, said clamping assembly fitting over said mounting post and said base member being bolted to said camera tripod.

13. A smartphone holder as in claim 1, further comprising a compact camera adaptor for connecting a compact camera to said smartphone holder, a housing of said compact camera adaptor being secured by said clamping assembly of said smartphone holder, said compact camera adaptor including an upwardly protruding tripod mounting bolt and an attached thumbwheel for controlling rotation thereof, said tripod mounting bolt and said thumbwheel being operative for securing a compact camera atop said compact camera adaptor.

14. A smartphone holder comprising:
a flexible central body member;
a pair of flexible side leg members positioned adjacent said central body member on opposite sides thereof, said central body member and said pair of side leg members being fixedly attached to each other at an upper end of said smartphone holder, said flexible central body member and said pair of flexible side leg members being separately outwardly bendable below a point of attachment to transform an otherwise linear shape of the smartphone holder into a self-supporting tripod shape;
a spring-loaded male USB connector adapted to protrude from a top end of said smartphone holder, said spring-loaded male USB connector being operative for pivoting movement between an open protruding position of use and a concealed closed position, said spring-loaded male USB connector serving to engage a mating USB connector of an external smartphone or other device; and
a two-sided reversible male USB connector protruding from a lower end of said smartphone holder for connection to a mating USB port of an external device, said spring-loaded male USB connector and said reversible male USB connector being electrically connected to each other by wires within said central body member of said smartphone holder.

15. A smartphone holder as in claim 1, further comprising a battery cavity located in said central body member, accessible from an underside thereof, for receiving a supplemental battery, said supplemental battery being electrically connected to said male electrical connector and to said two-sided reversible male USB connector, said supplemental battery thus being capable of supplying power to said male electrical connector to power a smartphone or other device connected thereto, said supplemental battery being charged when said two-sided reversible male USB connector is connected to an external USB power source.

16. A smartphone holder as in claim 14, further comprising a battery cavity located in said central body member, accessible from an underside thereof, for receiving a supplemental battery, said supplemental battery being electrically connected to said spring-loaded male USB connector and to said two-sided reversible male USB connector, said supplemental battery being capable of supplying power to said male electrical connector to power a smartphone or other device connected thereto, said supplemental battery being charged when said two-sided reversible male USB connector is connected to an external USB power source.

17. A smartphone holder as in claim 1, further comprising a notch formed in an underside surface of each of said flexible side leg members proximate a distal end thereof for preventing horizontal movement of a smartphone or other external device supported in a display position on said smartphone holder when said smartphone holder is lying flat with its underside facing upward and said flexible central body member is bent upwardly to thereby form a display easel.

18. A smartphone holder as in claim 14, further comprising a notch formed in an underside surface of each of said flexible side leg members proximate a distal end thereof for preventing horizontal movement of a smartphone or other external device supported in a display position on said smartphone holder when said smartphone holder is lying flat with its underside facing upward and said flexible central body member is bent upwardly to thereby form a display easel.
